(19) United States
(12) Patent Application Publication
(10) Pub. No.: US 2020/0108728 A1
(43) Pub. Date: Apr. 9, 2020

(54) ELECTRIC CAR CHARGING APPARATUS INSTALLED ON UTILITY POLE AND BASED ON LOAD OF TRANSFORMER CONNECTED TO DISTRIBUTION LINE, ELECTRIC CAR CHARGING SYSTEM, AND METHOD FOR CONTROLLING ELECTRIC CAR CHARGING APPARATUS INSTALLED ON UTILITY POLE

(71) Applicant: KOREA ELECTRIC POWER CORPORATION, Naju-si (KR)

(72) Inventors: Seong-Man KIM, Naju-si (KR); Hyun-Soo RYU, Naju-si (KR); Bong-Kun JIN, Naju-si (KR); Jae-Youl OH, Naju-si (KR); Do-Jin YOU, Naju-si (KR)

(21) Appl. No.: 16/500,802

(22) PCT Filed: Jun. 12, 2017
(86) PCT No.: PCT/KR2017/006069

§ 371 Date: Oct. 3, 2019

(30) Foreign Application Priority Data
Apr. 5, 2017 (KR) 10-2017-0044093

(51) Int. Cl. B60L 53/30; B60L 50/53; B60L 53/18

(52) U.S. Cl. CPC B60L 53/305; B60Y 2200/91; B60L 53/18; B60L 50/53

(57) ABSTRACT

An electric car charging apparatus installed on a utility pole according to one embodiment of the present invention may comprise: a first port for supplying power to an electric car; a second port for receiving power converted by a transformer connected to a distribution line; a breaker for switching the state, open or closed, between the first and second ports; a control unit for receiving load data of the transformer, and controlling the breaker so that the first port and second port are electrically open to each other when the load according to the load data is greater than the reference load.

### TECHNICAL FIELD

The present disclosure relates to an electric car charging apparatus installed on a utility pole and based on load of a transformer connected to a distribution line, an electric car charging system, and a method for controlling an electric car charging apparatus installed on a utility pole.

### BACKGROUND ART

As air pollution caused by depletion and overuse of fossil fuels has become a serious issue, there have been active studies into and development of renewable energies and an eco-friendly transportation means all over the world. As such eco-friendly transportation means, an electric vehicle (EV) has emerged. To increasingly use an electric vehicle, it has been necessary to expand infrastructure for charging such an electric vehicle.

### DISCLOSURE

### Technical Problem

An aspect of the present disclosure is to provide an electric car charging apparatus installed on a utility pole, an electric car charging system, and a method for controlling an electric car charging apparatus installed on a utility pole, which may contribute to expansion of infrastructure for charging an electric car by providing an environment in which power converted by a transformer connected to a distribution line may be safely used for charging an electric vehicle.

### Technical Solution

According to an aspect of the present disclosure, an electric car charging apparatus installed on a utility pole includes a first port configured to supply power to an electric car; a second port configured to be supplied with power converted by a transformer connected to a distribution line; a breaker configured to switch a state between the first port and the second port to an open state or a closed state; and a controller configured to receive load data of the transformer and to control the breaker to electrically open the first port and the second port to each other when a load corresponding to the load data is higher than reference load.

For example, the electric car charging apparatus may further include a communicator configured to receive the load data from an integrated data processing device processing data of the transformer or from an intelligent distribution box and to transmit no-charging data to a server when a load corresponding to the load data is higher than the reference load.

For example, the electric car charging apparatus may further include an input unit receiving charging request data; and an output unit outputting no-charging data when a load corresponding to the load data is higher than the reference load.

For example, the electric car charging apparatus may further include an enclosure configured to accommodate the breaker and to be installed on the utility pole.

For example, the electric car charging apparatus may further include a power cable electrically connecting the second port to the distribution line.

According to an aspect of the present disclosure, an electric car charging system includes a transformer connected to a distribution line and installed on a first utility pole; an integrated data processing device processing data of the transformer and generating load data; a charging device installed on the first utility pole or a second utility pole, supplied with power from the transformer, and charging an electric car; and an intelligent distribution box receiving the load data and inactivating the charging device when a load corresponding to the load data is higher than reference load.

According to an aspect of the present disclosure, a method for controlling an electric car charging apparatus installed on a utility pole includes receiving load data from an integrated data processing device configured to process data of a transformer connected to a distribution line and to generate the load data; comparing a load corresponding to the load data with reference load; and controlling whether to activate the electric car charging apparatus installed on a utility pole and supplied with power from the converter in accordance with a result of the comparison of the load with the reference load.

### Advantageous Effects

According to an example embodiment of the present disclosure, an electric car charging apparatus installed on a utility pole and based on load of a transformer connected to a distribution line, an electric car charging system, and a method for controlling an electric car charging apparatus installed on a utility pole may prevent a reduction in lifespan of a transformer connected to a distribution line and damages to the transformer even though the transformer connected to a distribution line is additionally used in charging an electric car, and the electric car charging apparatus may be stably supplied with power from the transformer connected to a distribution line and may charge an electric car.

Accordingly, an environment in which power converted by the transformer connected to a distribution line may be safely used to charge an electric car may be provided, and infrastructure for charging an electric car may be expanded.

### DESCRIPTION OF DRAWINGS

FIG. 1 is a view illustrating an electric car charging system according to an example embodiment of the present disclosure;

FIG. 2 is a block view illustrating an electric car charging apparatus installed on a utility pole according to an example embodiment of the present disclosure;

FIG. 3 is a block view illustrating an electric car charging apparatus installed on a utility pole in detail according to an example embodiment of the present disclosure;

FIGS. 4A to 4D are views illustrating a structure of an intelligent distribution box illustrated in FIGS. 1 and 3;

FIG. 5 is a view illustrating an example of an arrangement of a converter of an electric car charging system according to an example embodiment of the present disclosure;

FIG. 6 is a diagram illustrating an example of an arrangement of a converter of an electric car charging system according to an example embodiment of the present disclosure;

FIG. 7 is a diagram illustrating an example of an arrangement of a converter of an electric car charging system according to an example embodiment of the present disclosure; and

FIG. 8 is a flowchart illustrating a method for controlling an electric car charging apparatus installed on a utility pole according to an example embodiment of the present disclosure.

### BEST MODE FOR INVENTION

Hereinafter, example embodiments of the present disclosure will be described with reference to the accompanying drawings. It is to be understood that the various embodiments of the invention, although different, are not necessarily mutually exclusive. For example, structures, shapes, and features described in the example embodiments may be implemented in another example embodiment without departing from the spirit and scope of the present disclosure. Further, modifications of positions or arrangements of elements in the example embodiments may be made without departing from the spirit and scope of the present disclosure. Therefore, the following detailed description is, therefore, not to be taken in a limiting sense, and the scope of the present invention is limited only by appended claims, appropriately interpreted, along with the full range of equivalents to which the claims are entitled. In the drawings, the same reference numerals may refer to the same or similar function in various aspects.

In the description below, the example embodiments will be described in sufficient detail to allow those skilled in the art to easily practice the invention with reference to the accompanying drawings.

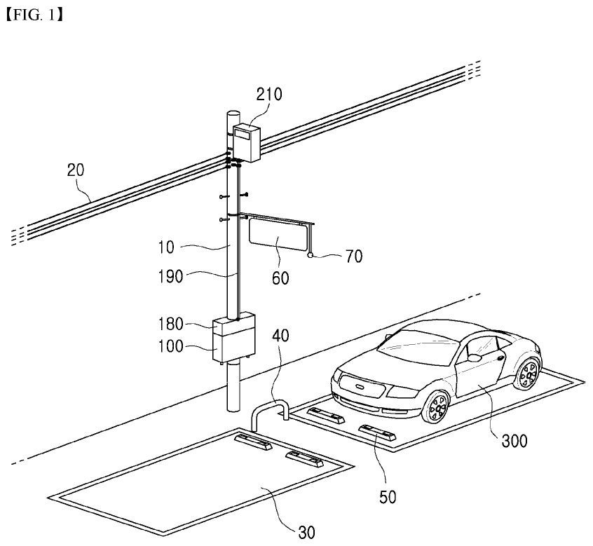

FIG. 1 is a view illustrating an electric car charging system according to an example embodiment.

Referring to FIG. 1, an electric car charging system in the example embodiment may include an electric car charging apparatus 100, an intelligent distribution box 180, an integrated data processing device 210, and a transformer (not illustrated). The electric car charging system may be provided in an electric car charging station including a utility pole 10, a distribution line 20, a parking space 30, a bollard for preventing collision between vehicles 40, a vehicle stopper 50, a charging station signboard 60, and an imaging device 70. The utility pole 10 is not limited to an electric pole, and may refer to a pole on which the electric car charging apparatus 100 may be installed and which may provide an environment in which electrical energy may be supplied from the distribution line and may be transferred to the electric car charging apparatus 100.

The electric car charging apparatus 100 may be configured to be installed on the utility pole 10, to be supplied with power from the transformer, and to charge an electric car 300. For example, the electric car charging apparatus 100 may be electrically connected to the distribution line 20 through a power cable 190 and may be supplied with power.

The transformer may be connected to the distribution line 20 and may convert high voltage power to low voltage power. For example, the transformer may be implemented as a pole transformer installed on the utility pole 10 or a second utility pole (not illustrated), and may also be implemented as a pad transformer installed on a road or around a pavement.

The integrated data processing device 210 may collect and process current, voltage, or power data of the transformer and may generate load data. The load data may be defined as total electric power converted by the transformer. When load of the transformer is relatively high, a lifespan of the transformer may decrease, a frequency of damages to the transformer may increase, and power supplied to the electric car charging apparatus 100 from the transformer may become stable.

The intelligent distribution box 180 may receive the load data, and when a load corresponding to the load data is higher than reference load, the intelligent distribution box 180 may inactivate the electric car charging apparatus 100. The inactivated electric car charging apparatus 100 may temporally stop charging.

Accordingly, the lifespan of the transformer may be extended, a frequency of damages to the transformer may decrease, and power supplied to the electric car charging apparatus 100 from the transformer may be stabilized.

In example embodiments, the intelligent distribution box 180 may be integrated with the electric car charging apparatus 100. In other words, when the electric car charging system does not include the intelligent distribution box 180, the electric car charging apparatus 100 may perform a function of the intelligent distribution box 180.

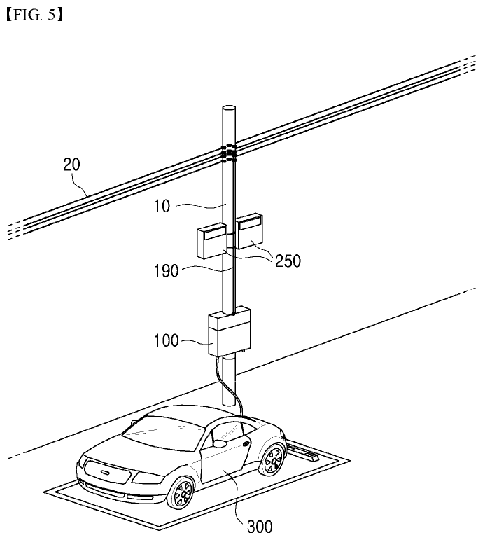

Power converted by the transformer may be converted once more by a converter described with reference to FIGS. 5 to 7 before being supplied to the electric car 300. In example embodiments, the converter may be included in the electric car charging apparatus 100, or may be separated from the electric car charging apparatus 100 as illustrated in FIGS. 5 to 7.

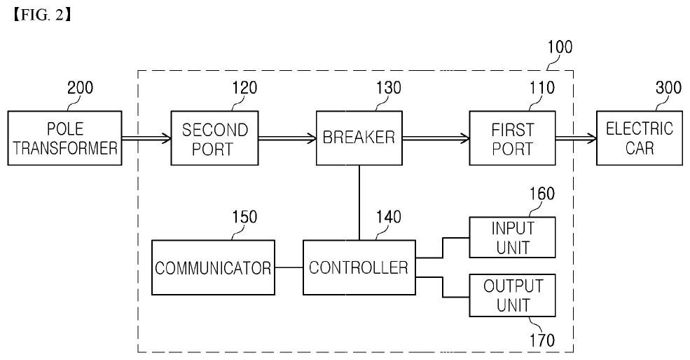

FIG. 2 is a block view illustrating an electric car charging apparatus installed on a utility pole according to an example embodiment.

Referring to FIG. 2, an electric car charging apparatus 100 in the example embodiment may include at least a portion of a first port 110, a second port 120, a breaker 130, a controller 140, a communicator 150, an input unit 160, and an output unit 170.

The first port 110 may be configured to supply power to an electric car 300.

The second port 120 may be configured to be supplied with power converted by a transformer 200 connected to a distribution line.

For example, the first and second ports 110 and 120 may be configured to be connected to a power cable to supply power by a wired method, or may be implemented as a coil to supply power in near-field by a wireless method.

The breaker 130 may switch a state between the first port 110 and the second port 120 to an open state or a closed state. Whether the electric car charging apparatus 100 charges the electric car 300 may be determined in accordance with the switching of the state to an open state or a closed state by the breaker 130.

The controller 140 may receive load data of the transformer 200 connected to the distribution line, and when a load corresponding to the load data is higher than reference load, the controller 140 may control the breaker 130 to electrically open the first port 110 and the second port 120 to each other. Accordingly, a lifespan of the transformer 200 connected to the distribution line may be extended, a frequency of damages to the transformer may decrease, and power supplied to the electric car charging apparatus 100 from the transformer may be stabilized.

The communicator 150 may receive load data from an integrated data processing device processing data of the transformer 200 connected to a distribution line or from an intelligent distribution box. When a load corresponding to the load data is higher than reference load, the communicator 150 may generate no-charging data, and may transmit the no-charging data to a server. Accordingly, a manager may manage a plurality of electric car charging apparatuses in an integrated manner.

The input unit 160 may receive charging request data from the electric car 300 or a driver. The charging request data may include charging method data, charging mode data and/or charging load data. The charging method data may include power voltage data, frequency data, data of whether current is direct current/alternating current, data of whether to use a wired method/a wireless method, and/or charging speed data, and the charging mode may include a rapid speed mode, an medium speed mode, and a low speed mode. The charging request data may be transferred to the controller 140. The controller 140 may control a switching time point of the breaker 130 based on the charging request data, may determine a power voltage, a frequency, whether current is direct current/alternating current, whether to use a wired method/a wireless method, and/or a charging speed, and may generate fare data based on the above-mentioned elements.

The output unit 170 may output data of a state of charging the electric car 300, may output the fare data, and may output data input by the input unit 160 for a driver to conveniently input data.

The output unit 170 may output no-charging data generated by the controller 140 when a load corresponding to load data of the transformer 200 connected to a distribution line is higher than the reference load.

The output unit 170 may be implemented as a human-machine interface (HMI) such as a touchscreen, a keypad, or the like, along with the input unit 160.

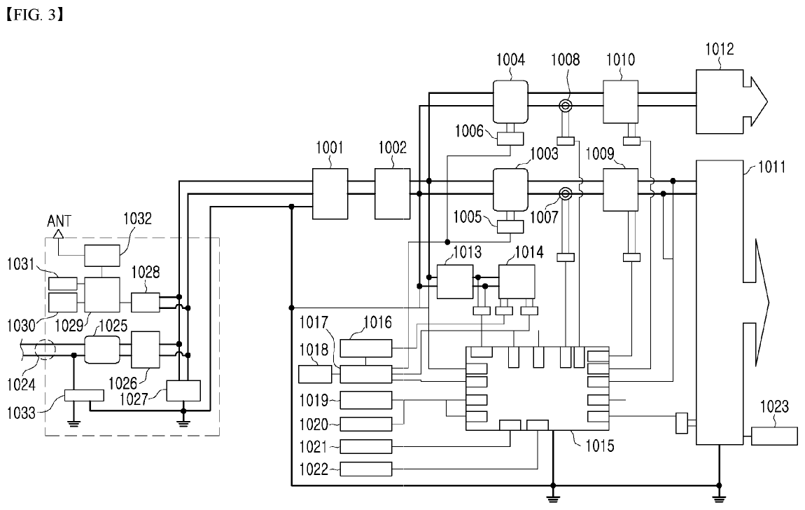

FIG. 3 is a block view illustrating an electric car charging apparatus installed on a utility pole in detail according to an example embodiment.

Referring to FIG. 3, an electric car charging apparatus may include a charging device AC terminal 1001, an earth leakage breaker 1002, a first watt-hour meter 1003, a second watt-hour meter 1004, a first watt-hour meter communication terminal box 1005, a second watt-hour meter communication terminal box 1006, a first current sensor 1007, a second current sensor 1008, a first magnet contactor 1009, a second magnet contactor 1010, a charging connector 1011, a charging outlet 1012, a noise filter 1013, a power supplying device 1014, a controller 1015, a card swipe machine 1016, a display 1017, a speaker 1018, an illumination device 1019, an emergency switch 1020, a door solenoid 1021, a plug sensor 1022, and a retractor 1023.

The charging device AC terminal 1001 may electrically connect the electric car charging apparatus to the intelligent distribution box, and may correspond to the second port illustrated in FIG. 2.

The earth leakage breaker 1002 may suspend the charging when an electric leakage occurs in the electric car charging apparatus. The earth leakage breaker 1002 may correspond to the breaker illustrated in FIG. 2.

The first watt-hour meter 1003 may measure electric power of charging power when the charging is performed in a first mode. For example, the first mode may be a low speed mode.

The second watt-hour meter 1004 may measure electric power of charging power when the charging is performed in a second mode. For example, the second mode may be a rapid speed mode.

Results of the measurement of the first and second watt-hour meters 1003 and 1004 may be used to generate fare data.

The first watt-hour meter communication terminal box 1005 may transmit the result of the measurement of the first watt-hour meter 1003 to the controller 1015 or to an external entity.

The second watt-hour meter communication terminal box 1006 may transmit the result of the measurement of the second watt-hour meter 1004 to the controller 1015 or to an external entity.

The first current sensor 1007 may measure current of power supplied to the electric car in the first mode.

The second current sensor 1008 may measure current of power supplied to the electric car in the second mode.

The current values measured by the first current sensor 1007 or the second current sensor 1008 may be used to a cut-off control of the earth leakage breaker 1002 performed by the controller 1015.

The first magnet contactor 1009 may control a charging amount in the first mode by on/off switching.

The second magnet contactor 1010 may control a charging amount in the second mode by on/off switching.

The charging connector 1011 may be configured to be electrically connected to the electric car to charge the electric car in the first mode, and may correspond to the first port illustrated in FIG. 2.

The charging outlet 1012 may be configured to be electrically connected to the electric car to charge the electric car in the second mode, and may correspond to the first mode illustrated in FIG. 2.

The noise filter 1013 may filter noise of charging power.

The power supplying device 1014 may supply operating power to the controller 1015, and may convert AC power to DC power. For example, the power supplying device 1014 may be implemented as a switch mode power supply (SMPS).

The controller 1015 may operate similarly to the controller illustrated in FIG. 2.

The card swipe machine 1016 may receive payment information from the electric car or a driver. For example, the payment information may correspond to at least one of various payment methods such as a credit card, a debit card, a mobile payment, and the like.

The display 1017 may visually display data output by the output unit illustrated in FIG. 2.

The speaker 1018 may auditorily generate data output by the output unit illustrated in FIG. 2.

The illumination device 1019 may output a light source directed to the charging connector 1011 and the charging outlet 1012 for convenience of a driver.

The emergency switch 1020 may suspend the charging in response to an input from the electric car or a driver.

The door solenoid 1021 may be configured to lock a storage box in which the charging connector 1011 is stored.

The plug sensor 1022 may monitor whether the charging connector 1011 is disposed in a certain position.

The retractor 1023 may allow a charging cable connected to the charging connector 1011 to be wound on a reel. Accordingly, the retractor 1023 may prevent the charging cable from being damaged by being rubbed against the ground.

Referring to FIG. 3, the intelligent distribution box may include at least a portion of a distribution board AC terminal 1024, a third watt-hour meter 1025, an AC input breaker 1026, a surge protector 1027, a distribution board power supplying device 1028, a distribution board control board 1029, an image processing device 1030, a signboard controller 1031, a wireless model 1032, and an earth ground 1033. As the intelligent distribution box may be integrated with the electric car charging apparatus, the elements included in the intelligent distribution box may also be included in the electric car charging apparatus.

The distribution board AC terminal 1024 may electrically connect the intelligent distribution box to a distribution line.

The third watt-hour meter 1025 may measure electrical energy of power passing through the intelligent distribution box.

The AC input breaker 1026 may cut off power supplied to the electric car charging apparatus from the intelligent distribution box.

The surge protector 1027 may protect power from a surge.

The distribution board power supplying device 1028 may supply operating power of the distribution board control board 1029, and may convert AC power to DC power. For example, the distribution board power supplying device 1028 may be implemented as a switch mode power supply (SMPS).

The distribution board control board 1029 may control overall operations of the intelligent distribution box.

The image processing device 1030 may control the image device illustrated in FIG. 1.

The signboard controller 1031 may control a charging station signboard illustrated in FIG. 1.

The wireless model 1032 may operate similarly to the communicator illustrated in FIG. 2.

The earth ground 1033 may provide a ground voltage to the intelligent distribution box.

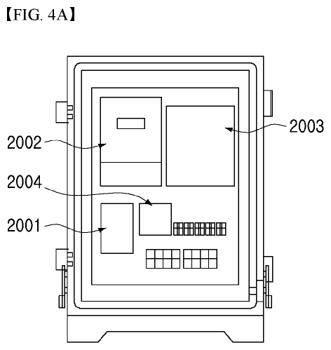

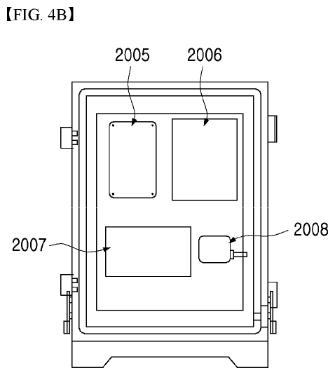

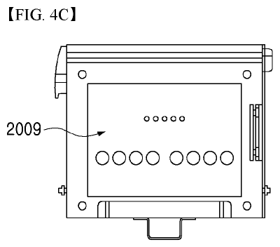

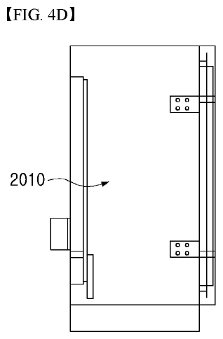

FIGS. 4A to 4D are views illustrating a structure of an intelligent distribution box illustrated in FIGS. 1 and 3.

FIG. 4A illustrates a front surface of the intelligent distribution box, FIG. 4B illustrates a rear surface of the intelligent distribution box, FIG. 4C illustrates a side surface of the intelligent distribution box, and FIG. 4D illustrates a lower surface of the intelligent distribution box.

Referring to FIGS. 4A to 4D, the intelligent distribution box may include at least a portion of a switch for wiring 2001, a watt-hour meter 2002, a surge protector 2003, a power supplying device 2004, a controller 2005, an image processing device 2006, a wireless modem 2007, an E-type modem 2008, a distribution board AC terminal 2009, and an enclosure 2010.

The enclosure 2010 may be attached to or detached from a utility pole, and a breaker, and the like, may be accommodated in the enclosure 2010.

As the intelligent distribution box may be integrated with the electric car charging apparatus described in the example embodiment, the elements illustrated in FIGS. 4A to 4D may be included in the electric car charging apparatus.

FIG. 5 is a view illustrating an example of an arrangement of a converter of an electric car charging system according to an example embodiment.

Referring to FIG. 5, a converter 250 converting power converted by a transformer connected to a distribution line 20 to power for charging may be separated from an electric car charging apparatus 100, and may be installed on a utility pole 10.

Generally, the converter 250 may have a weight or a volume relatively greater than those of the electric car charging apparatus 100. Accordingly, the electric car charging apparatus 100 from which the converter 250 is separated may have a reduced size, and even when the electric car charging apparatus 100 is installed on the utility pole 10, the electric car charging apparatus 100 may secure a sufficient degree of durability in which the electric car charging apparatus 100 may endure wind or external impacts.

The electric car charging apparatus 100 having improved durability may be easily installed on various types of or various ages of utility poles. Thus, the electric car charging system and the electric car charging apparatus 100 may provide an environment in which the electric car charging apparatus 100 may be easily installed on a utility pole such that the electric car charging system and the electric car charging apparatus 100 may contribute to expanding infrastructure for charging an electric car.

For example, the converter 250 may be installed on a position of the utility pole 10 higher than a position at which the electric car charging apparatus 100 is installed. Accordingly, the utility pole 10 may stably have a center of mass even though the electric car charging apparatus 100 and the converter 250 are installed on the utility pole 10.

Two or more converters 250 may be provided to stably support various charging modes. When two or more converters 250 are provided, the electric car charging apparatus 100 may stably use various charging modes, and an increasing weight or volume of the converter 250 may be distributed.

For example, the converter 250 may include a first converter converting power converted by the transformer to power for a low speed charging and supplying the power for a low speed charging to the electric car charging apparatus 100, and a second converter converting power converted by the transformer to power for a rapid speed charging and supplying the power for a rapid speed charging to the electric car charging apparatus 100.

Accordingly, the converter 250 may support various charging modes for the electric car charging apparatus 100 and may be stably installed on the utility pole 10.

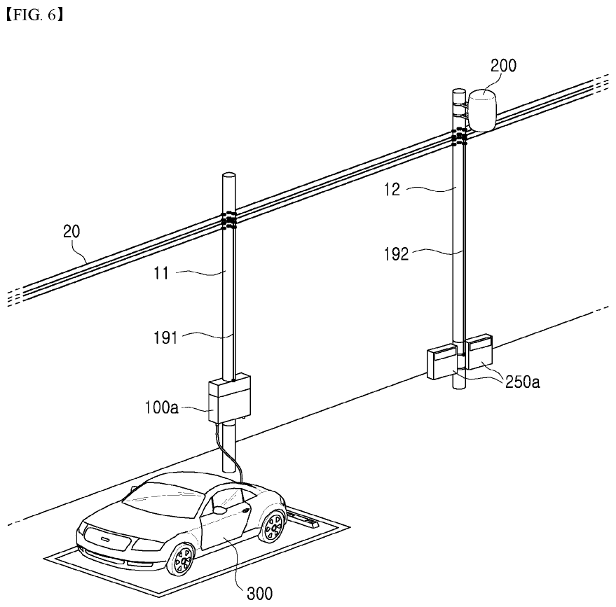

FIG. 6 is a diagram illustrating an example of an arrangement of a converter of an electric car charging system according to an example embodiment.

Referring to FIG. 6, a transformer 200 connected to a distribution line and a converter 250a may be installed on a second utility pole 12.

In other words, the converter 250a may be installed on the second utility pole 12, different from a first utility pole 11 on which an electric car charging apparatus 100a is installed. Accordingly, the converter 250a may be installed at a relatively low position on the second utility pole 12 or may be installed adjacent to the ground, thereby having a stable structure.

Power converted by the transformer 200 connected to a distribution line may be supplied to the converter 250a through a second power cable 192.

The power for charging converted by the converter 250a may be supplied to the electric car charging apparatus 100a through a distribution line 20 and a first power cable 191, or may be supplied to the electric car charging apparatus 100a through an underground cable (not illustrated).

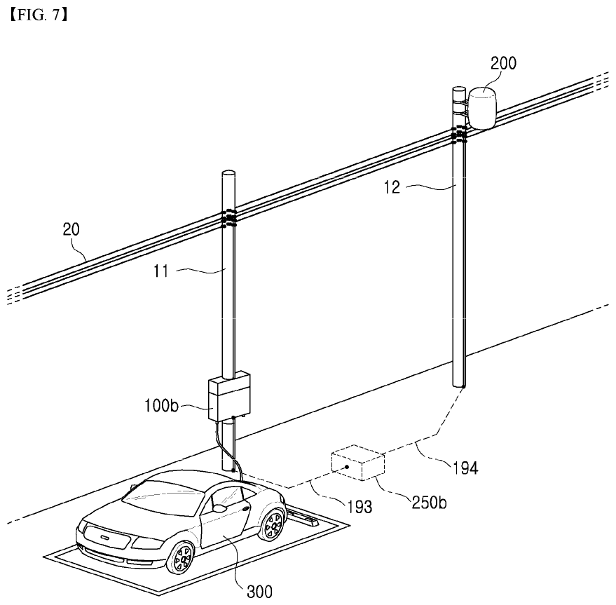

FIG. 7 is a diagram illustrating an example of an arrangement of a converter of an electric car charging system according to an example embodiment.

Referring to FIG. 7, a converter 250b may be spaced apart from a first utility pole 11 and a second utility pole 12. Accordingly, the converter 250b may be easily expanded.

The converter 250b may also be electrically connected to a first underground cable 193 and a second underground cable 194, and may be installed underground. Accordingly, the converter 250b may be prevented from being damaged by external impacts in advance.

The first underground cable 193 may be electrically connected to the electric car charging apparatus 100b, and the second underground cable 194 may be electrically connected to a transformer 200 connected to a distribution line. Accordingly, the electric car charging apparatus in the example embodiment may be supplied with power through the underground, as well as through the distribution line connected to the utility pole.

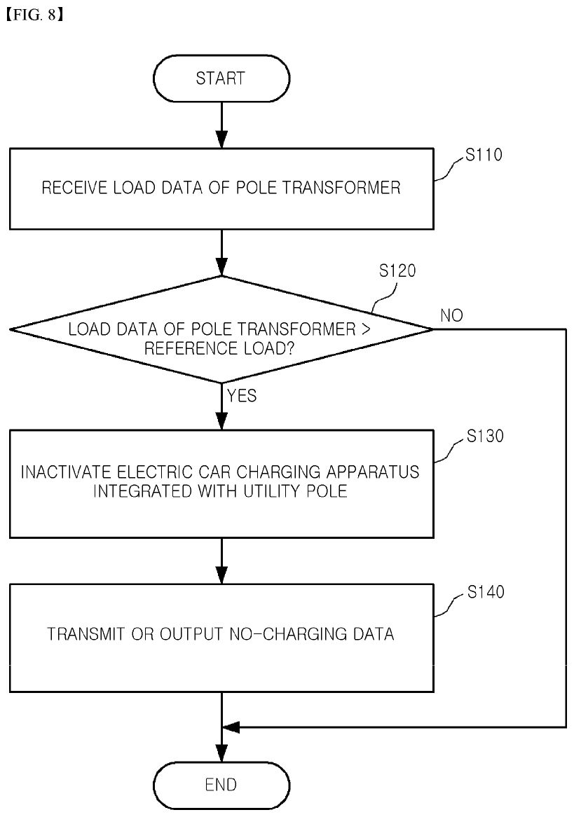

FIG. 8 is a flowchart illustrating a method for controlling an electric car charging apparatus installed on a utility pole according to an example embodiment.

Referring to FIG. 8, a method for controlling an electric car charging apparatus in the example embodiment may include receiving load data from an integrated data processing device processing data of a transformer connected to a distribution line and generating the load data (S110), comparing a load corresponding to the load data with reference load (S120), and controlling whether to activate the electric car charging apparatus supplied with power from the transformer in accordance with a result of the comparison of the load with the reference load (S130). The method may further include transmitting or outputting no-charging data when the electric car charging apparatus is inactivated (S140). The method may be performed by the electric car charging apparatus or the electric car charging system described with reference to FIGS. 1 to 7.

The method for controlling an electric car charging apparatus may be implemented by a computing environment including a processor, a memory, a storage, an input device, an output device, and a communication connection. For example, the processor and the memory may correspond to the controller described in the aforementioned example embodiments, the input device may correspond to the input unit described in the aforementioned example embodiments, the output device may correspond to the output unit described in the aforementioned example embodiments, and the communication connection may correspond to the communicator described in the aforementioned example embodiments.

The term “unit” in the example embodiments may refer to a software element, or a hardware element such as a field-programmable gate array (FPGA) or an ASIC, and the certain unit may perform certain functions. However, the term “unit” is not limited to software or hardware. The certain unit may be configured to be in a storage medium which may be addressed, or may be configured to reproduce one or more processors. Accordingly, as an example, the term “unit” may include elements such as software elements, object-oriented software elements, class elements, and task elements, and may include processes, functions, properties, procedures, sub-routines, segments of a program code, drivers, firmware, a microcode, a circuit, data, a database, data structures, tables, arrays, and variables. Functions provided in the elements and in a certain unit may be combined as a less number of elements and certain units, or may be divided into additional elements or certain units. Also, the elements and certain units may be implemented to reproduce one or more CPUs in a device or a system.

While the example embodiments have been shown and described above, it will be apparent to those skilled in the art that modifications and variations could be made without departing from the scope of the present invention as defined by the appended claims.

1. An electric car charging apparatus installed on a utility pole, the electric car charging apparatus comprising:
a first port configured to supply power to an electric car;
a second port configured to be supplied with power converted by a transformer connected to a distribution line;
a breaker configured to switch a state between the first port and the second port to an open state or a closed state; and
a controller configured to receive load data of the transformer and to control the breaker to electrically open the first port and the second port to each other when a load corresponding to the load data is higher than reference load.

2. The electric car charging apparatus of claim 1, further comprising:
a communicator configured to receive the load data from an integrated data processing device processing data of the transformer or from an intelligent distribution box and to transmit no-charging data to a server when a load corresponding to the load data is higher than the reference load.

3. The electric car charging apparatus of claim 1, further comprising:
an input unit receiving charging request data; and
an output unit outputting no-charging data when a load corresponding to the load data is higher than the reference load.

4. The electric car charging apparatus of claim 1, further comprising:
an enclosure configured to accommodate the breaker and to be installed on the utility pole.

5. The electric car charging apparatus of claim 1, further comprising:
a power cable electrically connecting the second port to the distribution line.

6. An electric car charging system, comprising:
a transformer connected to a distribution line and installed on a first utility pole;
an integrated data processing device processing data of the transformer and generating load data;
a charging device installed on the first utility pole or a second utility pole, supplied with power from the transformer, and charging an electric car; and
an intelligent distribution box receiving the load data and inactivating the charging device when a load corresponding to the load data is higher than reference load.

7. A method for controlling an electric car charging apparatus installed on a utility pole, the method comprising:
receiving load data from an integrated data processing device configured to process data of a transformer connected to a distribution line and to generate the load data;
comparing a load corresponding to the load data with reference load; and
controlling whether to activate the electric car charging apparatus installed on a utility pole and supplied with power from the converter in accordance with a result of the comparison of the load with the reference load.
